(19) United States
(12) Patent Application Publication
(10) Pub. No.: US 2007/0263478 A1
(43) Pub. Date: Nov. 15, 2007

(54) Hydraulic power system

(76) Inventor: Leon A. Burch, Prospect, CT (US)

Correspondence Address: EDWARDS ANGELL PALMER & DODGE LLP, P.O. BOX 55874, BOSTON, MA, 02205, US

(21) Appl. No.: 11/803,527

(22) Filed: May 15, 2007

Related U.S. Application Data
(60) Provisional application No. 60/800,543, filed on May 15, 2006.

(51) Int. Cl. B28C 5/42

(52) U.S. Cl. 366/61

(57) ABSTRACT

The invention provides a hydraulic power supply for fitting to a transit mixer truck including an engine and a hydraulic pump. The hydraulic pump is operably connected to the auxiliary engine to produce pressure in hydraulic conduits attached thereto. The conduits are configured to enable attachment of the hydraulic pump to a hydraulic motor of a mixing drum of the transit mixer truck. The invention also provides a method of retrofitting an independent hydraulic power supply to a transit mixer truck having hydraulically powered mixer drum, including the steps of disconnecting a first hydraulic pump from a hydraulic motor of the mixer drum, providing an auxiliary engine, providing a second hydraulic pump operably connected to the auxiliary engine to produce pressure in a hydraulic conduits attached thereto, and connecting the second hydraulic pump via said conduits to the hydraulic motor of the mixer drum.

### CROSS-REFERENCE TO RELATED APPLICATIONS

This application claims priority to U.S. Provisional Patent Application No. 60/800,543, filed May 15, 2006, which is incorporated herein by reference in its entirety.

### BACKGROUND OF THE INVENTION

1. Field of the Invention

The present invention relates to a hydraulic power system for powering a hydraulically powered device. Particularly, the present invention is directed to an alternative system for supplying power to turn the mixer drum of mobile mixers, such as those of truck-mounted concrete mixers.

2. Description of Related Art

Ready-mix concrete trucks, such as the transit truck 14 illustrated in FIG. 4, include a rotatable mixing drum 12 for holding a quantity of ready-mix concrete and a chassis 15. The chassis 15 is supported by a plurality of wheels 18, which are driven by an engine 19. In conventional transit trucks, the engine 19 also provides the power to rotate the mixing drum 12, typically by way of a mechanical or hydraulic linkage.

In use, transit trucks, such as that illustrated in FIG. 4, are operated for approximately 10 hours per day, if not more. While much of the time is spent traveling between a concrete mixing plant and a jobsite, a large percentage of the that time is spent waiting at a jobsite to pour the concrete, and in time actually pouring the concrete. In either of these cases, i.e., waiting or pouring, or in the process of mixing the concrete, which occurs during and immediately following loading of the truck, the transit truck does not typically need to move. However, the rotatable drum 12 must continually turn to keep aggregate suspended in the concrete mixture. Conventional transit trucks are configured such that the engine must run to power the mixing drum 12. Such engines typically have an output of about 400 horsepower, while a maximum of only about 60 horsepower is typically needed for turning the mixing drum 12. Accordingly, idling the relatively large, powerful engine for many hours per day is wasteful. Such waste results in un-needed expenditures for fuel and unnecessary engine exhaust emissions. Accordingly, there remains a need in the art for an alternative system to enable fuel and emissions savings. There also remains a need in the art for a system that is inexpensive and can be retrofitted on existing expensive machinery. The present invention provides a solution for these problems.

### SUMMARY OF THE INVENTION

The purpose and advantages of the present invention will be set forth in and apparent from the description that follows. Additional advantages of the invention will be realized and attained by the methods and systems particularly pointed out in the written description and claims hereof, as well as from the appended drawings.

Practice of the present invention can result in substantial fuel savings and can result in substantial reduction of wear of certain components of typical transit mixer trucks, thereby reducing maintenance costs. Such fuel savings may be greater than 1,500 gallons of fuel per year per vehicle, and maintenance savings may be between about $2,000 and $4,000 per year per vehicle. Moreover, use of an auxiliary engine in accordance with the invention can be run on so-called “off-road fuel,” which would result in additional fuel tax savings.

The subject hydraulic power system can replace or be added to an industrial vehicle to power hydraulic equipment when a main engine is not running. That is, in some embodiments, the subject hydraulic power system is the only source for hydraulic power, while in others it is an auxiliary system to a main hydraulic power system. Advantageously, the subject hydraulic power system can be used to power a mixer drum of a transit mixer truck, and additionally or alternatively be used to power other hydraulic equipment, such as hydraulically powered chutes.

To achieve these and other advantages and in accordance with the purpose of the invention, as embodied, the invention includes a transit truck having a hydraulic power system for providing hydraulic power to hydraulic-powered components of the vehicle. The transit truck includes a main engine for driving the truck, which is operably connected to a vehicle drive train for providing power to the driving wheels of the truck. The transit truck further includes an auxiliary engine and hydraulic pump, reservoir and hydraulic motor connected by a hydraulic circuit including hydraulic pipes. The auxiliary engine provides power to the hydraulic power system. The a hydraulic pump is operably connected to the auxiliary engine to produce pressure in the hydraulic circuit, while a hydraulic fluid reservoir acts to absorb any imbalances of flow, and can act to cool the hydraulic fluid. A heat exchanger can further be provided in the hydraulic circuit to cool the hydraulic fluid. The hydraulic motor is connected to the hydraulic circuit and receives pressurized hydraulic fluid through the circuit. The hydraulic motor is operably connected to a mixing drum of the transit truck in order to turn the mixing drum. Connections can be direct, or can include a gearbox connection, including a planetary gear train, if desired. Alternatively, a pulley arrangement can be provided between the hydraulic motor and mixing drum.

It is conceived that the present invention can be retrofitted onto existing machinery thorough a simple process. For example, since many existing transit mixers utilize hydraulic drive systems for turning mixing drums, an auxiliary unit, including an engine and hydraulic pump can be fitted to the transit mixer. The hydraulic pump can then simply be connected to the existing hydraulic motor, thus providing power to the motor to operate the mixing drum. The existing hydraulic pump, already connected to the main engine can then be removed.

Since typical transit mixers include hydraulic pumps that are connected to the main engine, such pumps must oftentimes rotate at speeds that are unnecessarily high to provide adequate power to turn a mixing drum. This results in unnecessary wear. Since the present invention allows the hydraulic pump to be decoupled from the main engine, the auxiliary engine can run at an optimal speed for powering hydraulic devices, such as the mixer drum.

The hydraulic pump can be of any suitable type, but in a preferred embodiment is a variable-displacement a swash-pate type pump. A transmission can be provided at any desired point, such as between the gear motor and the mixing drum, or between the auxiliary motor and hydraulic pump, for example. A speed control can be provided and configured to control any desired function of the system, such as control of valves, the displacement of one or more hydraulic pumps, speed of an engine or gear selection within a transmission, for example.

In accordance with the invention, the auxiliary engine and the main engine can receive fuel from a common fuel source, such as an existing diesel fuel tank. Alternatively, the subject hydraulic power system can be provided with an independent source of fuel.

Further in accordance with the invention, the transit truck can include a second hydraulic pump operably connected to the main engine, which pump is configured to provide pressure in the hydraulic circuit. A selector can be provided for selecting one or more of the hydraulic pumps to provide pressure to the hydraulic circuit.

In accordance with this aspect of the invention, the system can be integrated with an existing system. This can provide power the mixer drum only when the main engine is off, can supplement the main hydraulic system, and/or can serve as an emergency backup. The subject hydraulic power system can be integrated into an existing system by way of one or more valves to control the flow of hydraulic fluid. These valves can be manually operated, or can be controlled via a control unit which either receives input from an operator or automatically makes changes to the configuration. For example, the control unit can be configured to automatically start the auxiliary engine when the main engine is shut off. As another example, the control unit can be configured to start the auxiliary engine when the transit truck ascends an incline, to reduce the burden on the main engine and provide additional power for ascending the hill.

Further in accordance with the invention, a hydraulic power supply for fitting to a transit mixer truck is provided. The power supply includes an engine and a hydraulic pump. The engine provides power to the hydraulic power system, and the hydraulic pump is operably connected thereto. Hydraulic conduits are attached to the pump and are configured to enable attachment of the hydraulic pump to a hydraulic motor of a mixing drum of a transit mixer truck.

Additionally, the invention provides for a method of retrofitting an independent hydraulic power supply to a transit mixer truck having hydraulically powered mixer drum. The method includes disconnecting a first hydraulic pump from a hydraulic motor of the mixer drum, providing an auxiliary engine, and providing a second hydraulic pump operably connected to the auxiliary engine to produce pressure in a hydraulic conduits attached thereto. The method further includes connecting the second hydraulic pump via said conduits to the hydraulic motor of the mixer drum.

In accordance with the invention, the subject hydraulic power supply can be configured for use with front-discharge transit mixers, as that illustrated in FIG. 3, for example, or for use with rear-discharge transit mixers.

It is to be understood that both the foregoing general description and the following detailed description are exemplary and are intended to provide further explanation of the invention claimed. It is also to be understood that features described in connection with certain embodiments can also be applied to other embodiments set forth herein.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a schematic of a hydraulic power system in accordance with the invention.

FIG. 2 is a schematic of a second embodiment of a hydraulic power system in accordance with the invention.

FIG. 3 is a side view of a transit mixer truck in accordance with the invention.

FIG. 4 is a side view of a transit mixer truck in accordance with the prior art.

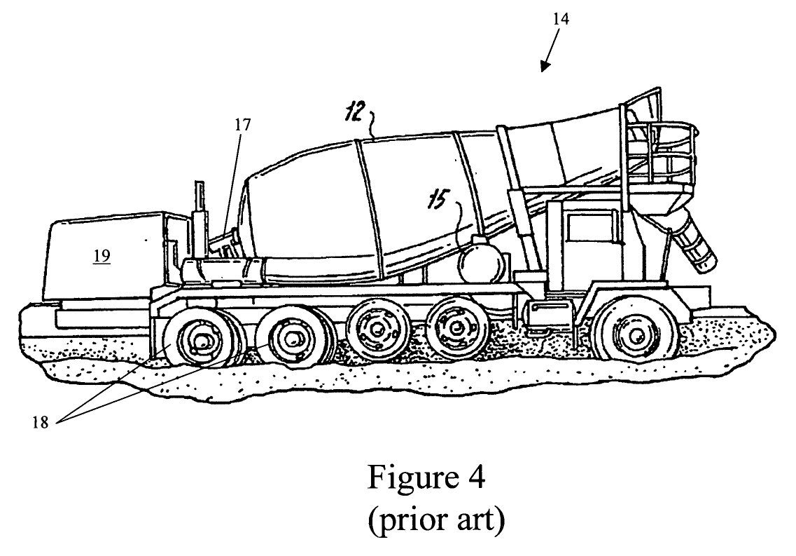

### DETAILED DESCRIPTION OF THE PREFERRED EMBODIMENT

Reference will now be made in detail to the present preferred embodiments of the invention, an example of which is illustrated in the accompanying drawings. The method and corresponding steps of the invention will be described in conjunction with the detailed description of the system.

The devices and methods presented herein may be used for providing power to one or more hydraulically powered devices. The present invention is particularly suited for providing hydraulic power to a hydraulic motor of a mixer drum of a transit mixer truck.

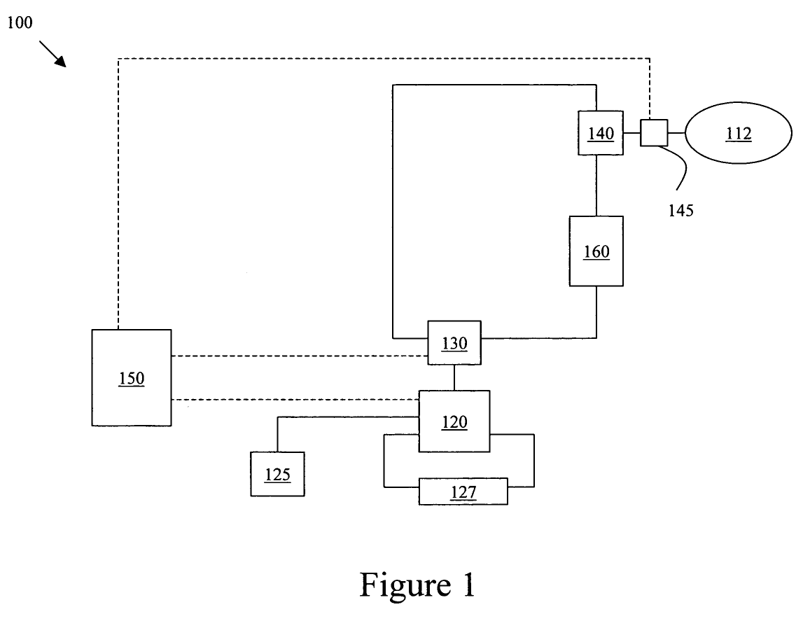

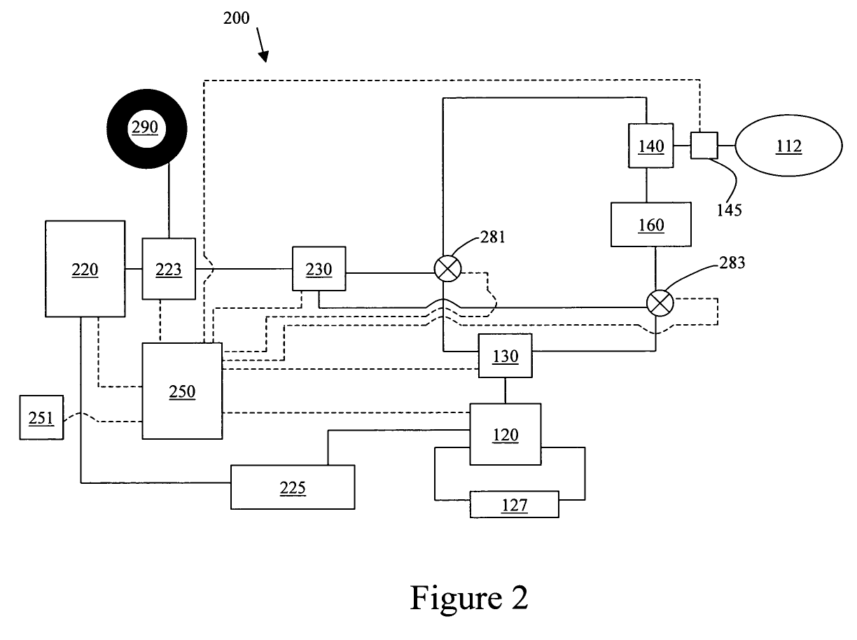

For purposes of illustration and not limitation, as embodied herein and as depicted in FIG. 1, a hydraulic power system 100 is provided with an auxiliary engine 120. The auxiliary engine is distinct from a main engine (e.g., 220 in FIG. 2), where the main engine drives the vehicle on which the subject power system 100 is carried. The auxiliary engine 120 is cooled by way of a radiator 127, but may alternatively be air cooled, for example.

The auxiliary engine can be powered by any desired fuel, such as diesel, gasoline, propane, liquefied petroleum (LP), liquefied natural gas (LNG), ethanol or other fuels. Alternatively, the auxiliary engine can be an electric motor. If electric, the power can be supplied directly from the truck, or can be supplied from an external source of electricity. Such capability may be desired where exhaust emissions would prove excessively troublesome, such as in an indoor space.

The auxiliary engine 120 is connected to a hydraulic pump 130 by way of a mechanical linkage, which is represented in FIG. 1 by a line. The hydraulic pump 130 can be of any suitable variety, but is preferably of the variable-displacement type, such as a swash plate-type pump described in U.S. Pat. No. 5,630,352 to Todd, which is expressly incorporated herein by reference in its entirety.

The hydraulic pump 130 is connected though conduits to a hydraulic motor 140, and can be connected to accessory hydraulic circuit components 160, which can include, for example, a filter or reservoir. The hydraulic motor can be of any suitable type such as a gear motor or the like. A transmission 145 can be provided between the hydraulic motor 140 and the mixer drum 112. By adjusting the transmission 145, hydraulic pump 130 and/or auxiliary engine speed, the rotational speed of the mixer drum 112 can be varied. A control unit 150 can be provided in accordance with the invention in order to control these aspects of the system. The throttle position on the auxiliary engine 120 can be controlled, as can the displacement of the hydraulic pump 130. Further, the desired gear can be selected by way of transmission 145. Alternatively, the transmission 145 can have a fixed gear ratio, simply gearing down the hydraulic motor 140, to provide sufficient torque to turn the mixer drum 112. The control unit connections are indicated by way of dashed lines in FIG. 1.

The entire hydraulic system 100 can be mounted to a secure point on the body of a transit truck, on which the system will be utilized.

FIG. 2 illustrates an alternative embodiment of the subject hydraulic system 200. In the embodiment of FIG. 2, the system 100 of FIG. 1 is essentially integrated into that of a typical transit mixer truck. The hydraulic pump 130, auxiliary engine, radiator 127, hydraulic motor 140, transmission 145, mixer drum 112 and hydraulic circuit components 160 remain unchanged.

The main vehicle hydraulic system includes a main engine 220, transfer case 223 and second hydraulic pump 230. The engine power is transferred from the main engine 220 to transfer case 223, where it is divided between drive train 290 and the second hydraulic pump 230. As illustrated, a common fuel tank 225 is shared between the main engine 220 and the auxiliary engine 120.

The hydraulic circuits of each of the main and auxiliary hydraulic systems are interconnected via valves 281 and 283. The valves can be either two-way or three-way valves. By enabling both hydraulic pumps 130, 230 to operate simultaneously, an increased hydraulic fluid follow and/or pressure can be obtained to the hydraulic motor 140, which may be desirable under heavy loads. Preferably, however, the valves 281, 283 enable the hydraulic supply to be switched between either the main or the auxiliary hydraulic circuits. The second hydraulic pump 230 corresponds to the main hydraulic circuit, and the first hydraulic pump 130 corresponds to the auxiliary hydraulic circuit in this embodiment.

The control unit 250 is connected to the main engine 220, auxiliary engine 120, transfer case 223, the first and second hydraulic pumps 130, 230, the transmission 145, incline sensor 251 and each of the valves 281, 283. As in FIG. 1, the control unit connections are indicated by way of dashed lines in FIG. 2.

In one embodiment, if the control unit is provided with instructions from the user that the mixer drum 112 should be running at a particular speed, the control unit would respond as follows. Upon sensing main engine shut off (such as when the transit truck must wait to unload), the control unit can disengage the second hydraulic pump 230 by shifting the transfer case 223 appropriately. The control unit 250 will switch valves 281 and 283 such that the hydraulic motor 140 receives flow from the first hydraulic pump 130. The control unit will then start the auxiliary engine 120 and adjust the displacement of the first hydraulic pump 130 to result in the desired rotation speed of the mixer drum 112. When the main engine is restarted, the reverse steps will be performed.

In another situation, the mixer truck is ascending a steep hill, while the main hydraulic system is engaged. Accordingly, the control unit will receive incline information from the incline sensor, and will shift the transfer case 223 to disconnect power delivery to the second hydraulic pump 230. The control unit 250 will switch valves 281 and 283 such that the hydraulic motor 140 receives flow from the first hydraulic pump 130, and the control unit 250 will start the auxiliary engine 120 and adjust the displacement of the first hydraulic pump 130 to result in the desired rotation speed of the mixer drum 112. When the transit truck reaches a level area for a predetermined period of time, the reverse steps will be carried out to switch the mixer drum back to the main engine.

In alternative embodiments, the control unit 250 can also adjust the displacement of the variable-displacement pump to reduce load on the main engine 220. In any embodiment, the system can be provided with a manual arrangement where an operator manually switches over the hydraulic systems by adjusting the valves appropriately.

Depending on the precise embodiment, a direct mechanical link can be provided between an auxiliary motor and the mixer drum. Such link can utilize belts and pulleys, chains and gears, shafts and gearboxes or combinations thereof. With a direct mechanical link, the main engine need not be disconnected, provided that the auxiliary power system is provided with a component such as a one-way clutch.

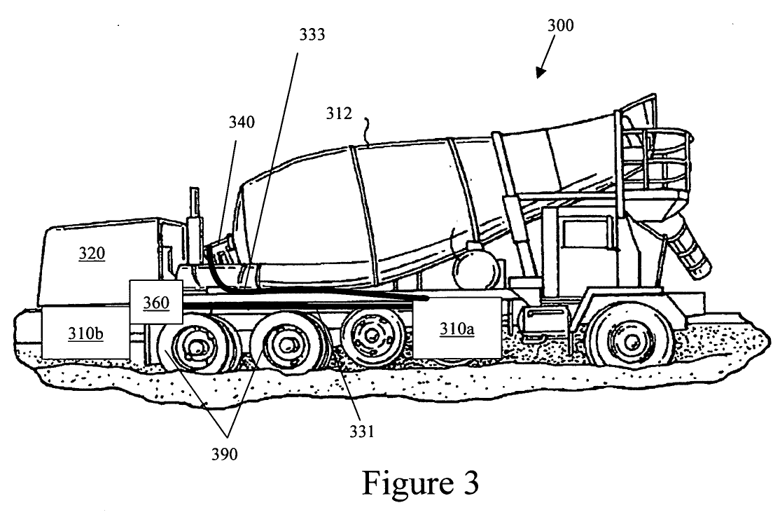

FIG. 3 is an example representation of a transit mixer truck 300 having a hydraulic power system in accordance with the invention. An auxiliary engine and hydraulic pump are housed in unit 310a, in front of drive wheels 390, but alternately can be provided in position 310b, below the main engine 320, as illustrated. Hydraulic fluid reservoir 360 supplies hydraulic fluid to the system via conduit 331. Conduits 333 deliver pressurized fluid to the hydraulic motor 340 from the hydraulic pump, and return hydraulic fluid to the system. the hydraulic motor then turns mixer drum 312.

The methods and systems of the present invention, as described above and shown in the drawings, provide for a hydraulic power system with superior versatility, and which allows for significant fuel savings. It will be apparent to those skilled in the art that various modifications and variations can be made to the device and method of the present invention without departing from the spirit or scope of the invention. Thus, it is intended that the present invention include modifications and variations that are within the scope of the appended claims and their equivalents.

What is claimed is:

1. A transit truck having a hydraulic power system for providing hydraulic power to hydraulic-powered components of the vehicle, the transit truck comprising:
a) a main engine for driving the transit truck, the main engine being operably connected to a vehicle drive train for providing power drive wheels;
b) an auxiliary engine for providing power to the hydraulic power system;
c) a hydraulic circuit including hydraulic conduits to deliver hydraulic fluid between components of the hydraulic power system;
c) a hydraulic pump operably connected to the auxiliary engine to produce pressure in the hydraulic circuit;
d) a hydraulic reservoir configured to provide a supply of hydraulic fluid to the hydraulic power system; and
e) a hydraulic motor connected to the hydraulic circuit, receiving pressurized hydraulic fluid therefrom, the hydraulic motor being operably connected to a mixing drum of the transit truck to turn the mixing drum.

2. The transit truck of claim 1, wherein the auxiliary engine is a diesel-powered engine.

3. The transit truck of claim 1, wherein the auxiliary engine and the main engine receive fuel from a common fuel source.

4. The transit truck of claim 1, wherein the hydraulic pump is a swash-pate type pump having at least one reciprocating piston.

5. The transit truck of claim 1, wherein the transit truck further comprises:
a) a second hydraulic pump operably connected to the main engine, the second hydraulic pump being configured to provide pressure in the hydraulic circuit; and
b) a selector for selecting one or more of the hydraulic pumps to provide pressure to the hydraulic circuit.

6. The transit truck of claim 5, wherein the selector is at least one valve.

7. The transit truck of claim 5, wherein the selector automatically selects which of the one or more of the hydraulic pumps will provide pressure to the hydraulic circuit.

8. The transit truck of claim 5, wherein a user manually selects which of the one or more of the hydraulic pumps will provide pressure to the hydraulic circuit.

9. A hydraulic power supply for fitting to a transit mixer truck, the power supply comprising:
a) an engine for providing power to the hydraulic power system; and
b) a hydraulic pump operably connected to the auxiliary engine to produce pressure in hydraulic conduits attached thereto, the conduits being configured to enable attachment of the hydraulic pump to a hydraulic motor of a mixing drum of the transit mixer truck.

10. A method of retrofitting an independent hydraulic power supply to a transit mixer truck having hydraulically powered mixer drum, the method comprising:
a) disconnecting a first hydraulic pump from a hydraulic motor of the mixer drum;
b) providing an auxiliary engine;
c) providing a second hydraulic pump operably connected to the auxiliary engine to produce pressure in a hydraulic conduits attached thereto; and
d) connecting the second hydraulic pump via said conduits to the hydraulic motor of the mixer drum.
